(19) United States
(12) Patent Application Publication
(10) Pub. No.: US 2010/0289631 A1
(43) Pub. Date: Nov. 18, 2010

(54) DUAL-MODE VEHICLE REAR VISION SYSTEM

(75) Inventors: Manoharprasad K. Rao, Novi, MI (US); Mark A. Cuddihy, New Boston, MI (US); Tai Luu, Westland, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/464,186

(22) Filed: May 12, 2009

(51) Int. Cl. B60Q 1/00; B60R 21/0134; B60T 7/12; H04N 7/18

(52) U.S. Cl. 340/435; 701/45; 701/70; 348/148

(57) ABSTRACT

A dual-mode rear vision system for an automotive vehicle includes an electro-optical imaging device operable in a short range mode to image a backup region immediately rearward of the vehicle and operable in a long range mode to image a collision threat region rearward of the backup region. The imaging device assumes the short range mode when the vehicle is in a reverse travel mode and assumes the long range mode when the vehicle is in a non-reverse travel mode. An electronic control module (ECM) analyzes imagery from the imaging device to detect backup hazards when in the reverse travel mode, and to detect rear collision threats when in the non-reverse travel mode. The ECM activates an occupant protection system if a collision threat is detected, and generates a driver alert and/or a braking intervention if a backup hazard is detected.

### BACKGROUND

1. Technical Field

The present invention relates generally to rear vision systems for passenger vehicles and specifically to a rear vision system providing both rear collision warning and backup hazard display/detection.

2. Background Art

It is known to equip automotive vehicles with a rear-view camera system to augment rear-view mirrors by providing the vehicle driver with a real-time image of the environment behind the vehicle during reverse motion of the vehicle. In such systems, a small video camera is positioned at the rear of the vehicle and aimed to cover the area immediately behind the vehicle. The image from the camera is displayed on a video screen located on the instrument panel or other position where it can be conveniently viewed by the driver.

It has further been proposed to use digital image processing (also known as artificial vision) to analyze the scene behind the vehicle, identify objects of which the driver should be aware when backing-up (pedestrians, bicyclists, other vehicles, fixed obstructions, etc.), and alert the driver to any such objects so that they may be safely avoided. Such artificial vision systems may include an electro-optical sensor, such as a CCD (charge-coupled device) or CMOS (complimentary metal-oxide semiconductor) device, the digital output of which is passed to a digital signal processor or other computational device for scene analysis.

U.S. Pat. No. 7,158,015, “VISION-BASED METHOD AND SYSTEM FOR AUTOMOTIVE PARKING AID, REVERSING AID, AND PRE-COLLISION SENSING APPLICATION,” teaches a system using an array of video sensors to provide coverage of several different areas around a vehicle. The disclosed system includes a rearward vision system that is operable in a reversing-aid mode when the vehicle's transmission is in reverse gear. In the reversing aid mode, a rear vision sensor mounted in or near a rear bumper of the vehicle monitors a sensing zone relatively close (approximately 2.0 m. to 5.0 m.) behind the vehicle.

The rearward vision system is also operable in a pre-collision sensing mode when the vehicle's transmission is in a forward gear. In the pre-collision sensing mode, a second rear vision sensor mounted near a rear edge of the vehicle roof is used to detect objects at a greater distance (as compared with the reversing-aid mode) from the vehicle.

The need for two separate rear vision sensors adds to the cost and overall complexity of the rearward vision system.

### SUMMARY

In a disclosed embodiment of the invention, a dual-mode rear vision system for a vehicle comprises an electro-optical imaging device mounted inside of the vehicle passenger cabin. The imaging device, also referred to as a camera, is operable in a short range mode to image a backup region immediately rearward of the vehicle and alternatively operable in a long range mode to image a collision threat region rearward of the backup region. The camera operates in the short range mode when a vehicle powertrain is in a reverse travel mode and operates in the long range mode when the vehicle powertrain is in a non-reverse travel mode. The system further comprises at least one electronic control module (ECM) operable when the vehicle is in the reverse travel mode to analyze imagery from the camera and detect a backup hazard, and operable when the vehicle is in the forward travel mode to analyze imagery from the camera and detect a rear collision threat such as a second vehicle approaching rapidly from behind.

Upon detection of a collision threat or a backup hazard, the ECM directs a function change in at least one vehicle system. If a collision threat is detected the ECM may activate an occupant safety system such as a seatbelt pre-tensioner, an airbag, or an active whip-lash preventing head rest. The dual-mode rear vision system is thus able to improve occupant safety by reducing or mitigating injuries that may be caused by a rear impact.

If a backup hazard is detected the ECM may activate an alerting device to provide a sensory alert to the driver, and/or may activate a vehicle braking system to slow or stop rearward movement of the vehicle if necessary to avoid striking the object that constitutes the backup hazard.

According to another disclosed embodiment of the invention, a method of operating a rear vision system for a vehicle comprises the steps of detecting a status of a vehicle powertrain as being in either a reverse travel mode or a non-reverse travel mode; upon detection of the reverse travel mode, placing an electro-optical imaging device in a short range mode wherein the imaging device images a region rearward of the vehicle; upon detection of the non-reverse travel mode, placing the imaging device in a long range mode wherein the imaging device is adapted to image a collision threat region rearward of the backup region; when the imaging device is in the short range mode, operating at least one electronic control module to analyze imagery from the imaging device and detect a backup hazard; when the imaging device is in the long range mode, operating the at least one electronic control module to analyze imagery from the imaging device and detect a collision threat; and causing a function change in at least one vehicle system based upon detection of at least one of the collision threat and the backup hazard.

### BRIEF DESCRIPTION OF THE DRAWINGS

The features of the present invention are set forth with particularity in the appended claims. The present invention, both to its organization and manner of operation, together with further objectives and advantages thereof, may be best understood with reference to the following description, taken in connection with the accompanying drawings in which:

FIG. 1 is an overall schematic view of a passenger vehicle having a dual-mode rear vision system;

FIG. 2 is a schematic side view of camera and movable mount of a dual-mode rear vision system;

FIG. 3 is a schematic illustration of a first embodiment of a dual-mode vision system;

FIG. 4 is a schematic illustration of a second embodiment of a dual-mode vision system;

FIG. 5 illustrates an alternative embodiment of the imaging system of a dual mode vision system.

### DETAILED DESCRIPTION

By way of example, a system and method for implementing the present invention is described below. The system and methodology may be adapted, modified or rearranged to best fit a particular implementation without departing from the scope of the present invention.

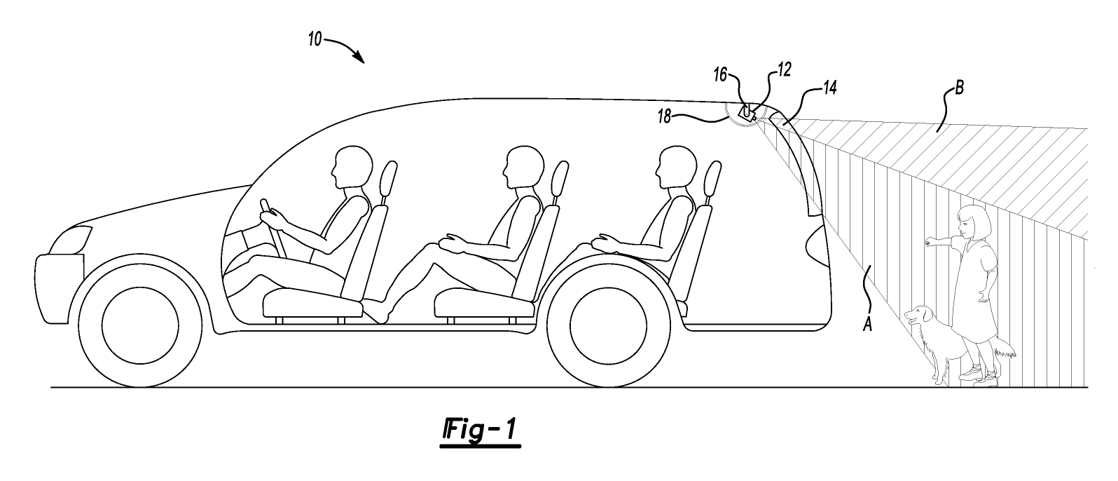

Referring to FIG. 1, a vehicle 10 is equipped with an electro-optical imaging device 12, hereafter referred to as a camera, located adjacent the upper rear portion of the passenger compartment near to the juncture between a rear window 14 and the interior of the vehicle roof. Camera 12 is retained in a movable mount 16 and preferably enclosed by a housing 18. Housing 18 may be integrated with the headliner forming the inner surface of the roof, or it may be a separate component. Camera 12 may operate in the visible, near-infrared, or any appropriate spectrum, and may employ a CCD (charge-coupled device) or CMOS (complimentary metal-oxide semiconductor) image sensor. Housing 18 may have one or more openings (not shown) located at positions through which the camera 12 points, or those positions may be transparent to the spectrum utilized by camera 12.

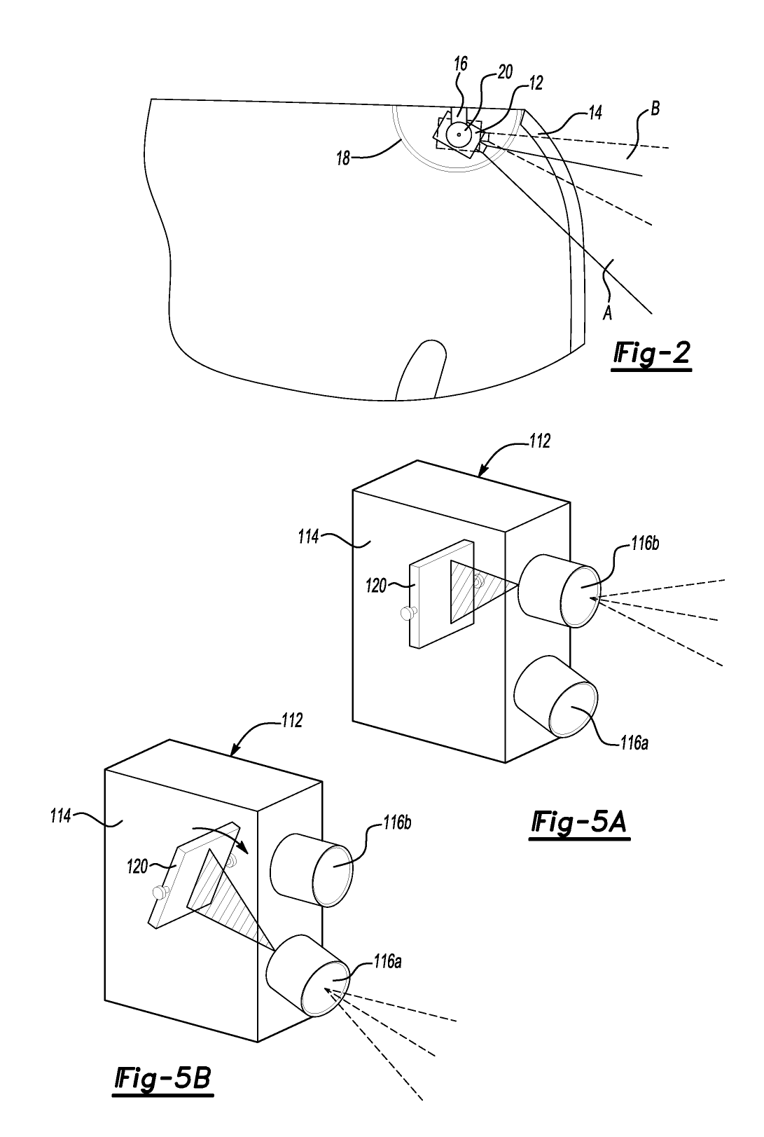

As shown schematically in FIG. 2, movable mount 16 includes a drive unit 20 operable to rotate camera 12 about an axis oriented generally parallel with the lateral axis of the vehicle. Drive unit 20 may be electrically powered and may, for example, be a stepper motor.

Movable mount 16 permits camera 12 to move between two alternative positions. In a short range view position (shown in FIG. 2 in solid lines), camera 12 assumes a pointing angle that is oriented relatively steeply downward so that its field-of-view covers a region relatively close to the rear of vehicle, indicated as Region A in FIG. 1. This region will hereafter be referred to as the backup region. In a long range view position, camera 12 assumes a pointing angle oriented relatively less steeply downward (compared with the short range view position) so that its field-of-view covers a region that lies relatively far from the rear of vehicle and behind the backup region, indicated as Region B in FIG. 1. This region will hereafter be referred to as the collision threat region.

Camera 12 points through the rear window 14 of vehicle 10 in both the short range view and long range view positions. It is therefore advantageous to position the camera 12 so that it points through a portion of the rear window 14 that is swept by a wiper blade (not shown) or otherwise cleaned to keep it relatively clear of rain, snow, dirt, or other matter that may obstruct the view of camera 12.

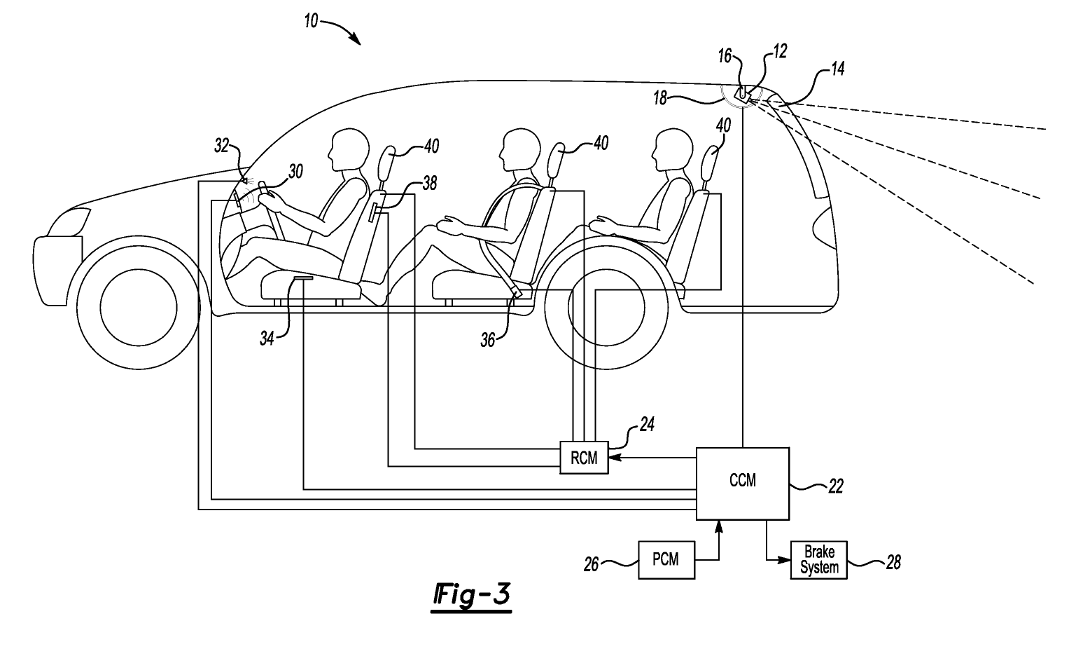

Referring now to FIG. 3, a camera 12 control module (CCM) 22 is electronically interfaced with camera 12 and movable mount 16 to control movement and other functionality of the camera 12. CCM 22 is an electronic control module that uses artificial vision software to processes the digital imagery received from camera 12 and perform object detection, recognition, and/or classification. CCM 22 is in electronic communication with other vehicle systems including a restraints control module (RCM) 24, a powertrain control module (PCM) 26, and a vehicle braking system 28.

CCM 22 may also be electronically interfaced with one or more devices capable of providing a sensory alert to the driver. Such alerting devices are shown in FIG. 3 to include a video screen 30, an audio speaker 32 (horn, buzzer, or beeper), and a haptic alerting device 34.

RCM 24 is an electronic control module interfaced with and controlling operation of one or more occupant restraint systems associated with one or more seating positions in the passenger compartment. Examples of such safety systems are seatbelt pre-tensioners 36, airbags 38, and movable, whiplash-preventing headrests 40. For clarity, FIG. 3 primarily shows safety systems associated with the second seating row, but RCM 24 may control safety systems associated with any seating position in any seating row. As is well known in the vehicle safety arts, RCM 24 receives signals from one or more crash sensors or pre-crash sensors (not shown) and controls actuation of the restraint systems as required to maximize occupant safety in the event of a crash.

PCM 26 controls and/or monitors all or parts of the functions of the vehicle's powertrain (not shown). The present invention is applicable to any type of vehicle powertrain, including those using a conventional internal combustion engine, a hybrid electric system, a pure electric system, and a fuel cell electric system.

CCM 22 receives information from PCM 26 indicating whether the vehicle powertrain is in a reverse travel mode, a forward travel mode, or a parking/stationary mode. For convenience of terminology, the forward travel mode and parking/stationary mode will hereafter be referred to together as constituting a non-reverse travel mode. When PCM 26 indicates that the vehicle powertrain is in a reverse travel mode, CCM 22 instructs camera 12 to operate in the short range mode. In the embodiment of camera 12 shown in FIG. 2, the short range mode comprises movement of camera 12 to the short range view position wherein the camera 12 is oriented to image the backup region A. Camera 12 may, depending upon its positioning and the width of the field-of-view of the lens, also image the environment somewhat to the left and right sides of the vehicle. The short range mode of camera 12 may include other system characteristics, as described more fully below.

When camera 12 is in the short range mode, CCM 22 receives digital images of the backup region from camera 12 and applies image processing to detect objects that may be classified as backup hazards. Backup hazards may include any object that may obstruct rearward travel of the vehicle and/or constitute a safety hazard. If the vehicle is equipped with other rearward-looking sensors, such as an ultrasonic, radio frequency (RF) radar, or laser radar (LIDAR) system, information from those sensors may be used in combination with (fused with) the video image information to detect and/or classify objects.

When an object in the backup region is identified by CCM 22 as a being a backup hazard, or otherwise of possible interest to the driver, a sensory alert is provided to the driver. A sensory alert may, for example, take the form of a visible signal provided by video screen 30, an audible alert provided by speaker 32, and/or a haptic alert provided by haptic alerting device 34.

Detection of a backup hazard may also trigger an automatic intervention in the vehicle powertrain and/or braking system 28 to slow or stop rearward motion of the vehicle if necessary to avoid striking the object. It is further possible to display the image of the backup region on video display screen 30 for viewing by the driver.

When PCM 26 indicates the vehicle powertrain is in a non-reverse travel mode, CCM 22 instructs camera 12 to operate in the long range mode. In the embodiment shown in FIG. 2, the long range mode comprises movement of camera 12 to the long range view position wherein the camera 12 is oriented to image the collision threat region B.

When camera 12 is in the long range mode, CCM 22 receives digital images of the rear collision threat region from the camera and applies image processing to detect and/or identify objects that constitute collision threats. If the vehicle is equipped with other rearward-looking sensors, such as an ultrasonic, RF radar, or laser radar (LIDAR) system, information from those sensors may be used in combination with (fused with) the video image information to detect and/or classify objects.

The determination that a particular object is a collision threat may be made based upon some combination of object size, position, closing velocity, and acceleration relative to vehicle. Algorithms for making such determinations using an electro-optical sensor alone or in combination with other types of sensors (as listed above) are well known in the vehicle safety art.

If CCM 22 determines that an object is a collision threat, this is communicated to RCM 24. RCM 24 uses this information as an input in making decisions as to the operating mode or status of one or more occupant safety systems. RCM 24 will typically receive inputs from many other vehicle systems (not shown) and apply pre-programmed logic to make the operating mode and/or status decisions. For example, RCM 24 may, at an appropriate time prior to the collision threat object impacting vehicle, activate seatbelt pre-tensioners 36, airbags 38, movable headrests 40, and/or other safety devices for one or more seating positions.

Visible, audible, and/or haptic alerts may also be provided to the driver or other vehicle occupants to warn them prior to a collision.

The sizes of the backup region and collision threat region, as well as the locations of those regions relative to vehicle, are selected to provide the maximum likelihood of detecting the types of objects that are of interest in the particular operating modes. The image processing algorithms utilized by CCM 22 in the two alternative modes may also be different. For example, in the backup mode the algorithms may be optimized to detect relatively small objects that are close to and moving slowly relative to vehicle. In the collision warning mode the algorithms may be optimized to detect relatively large objects that are farther from and moving quickly relative to vehicle.

The fields-of-view of the short range mode and long range mode may be immediately adjacent to one another, as shown in FIG. 1, or there may be a gap between the two regions, or they may overlap by some amount.

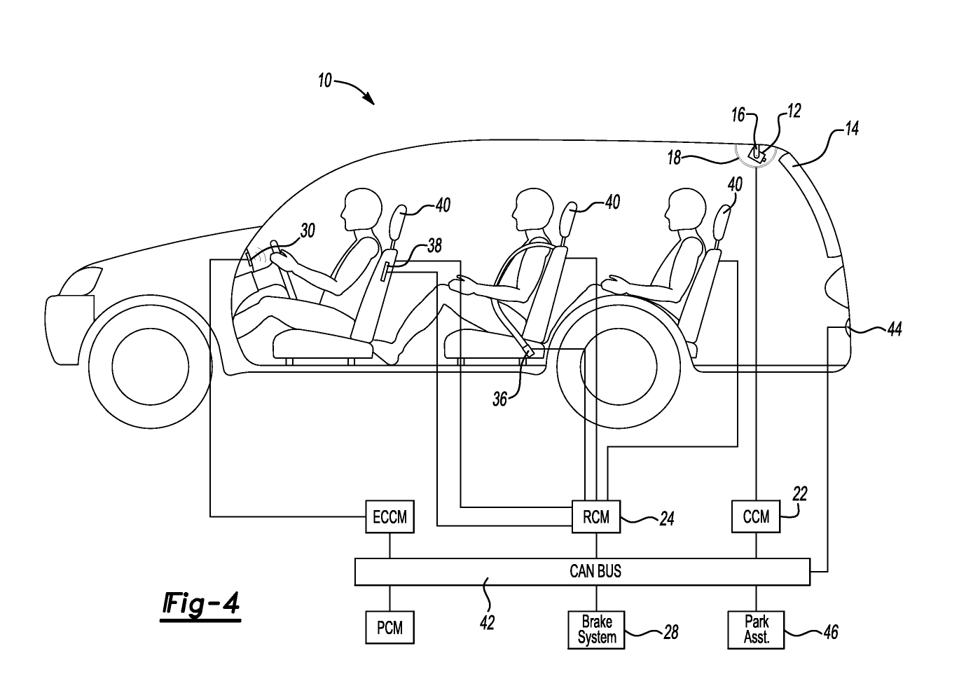

FIG. 4 schematically illustrates a second embodiment of a system according to the invention. Components of this embodiment that serve essentially the same or similar function as the components described in relation to FIG. 3 are numbered identically to those of FIG. 3. In this embodiment, a controller-area network (CAN) bus 42 is used to enable communications between various electronic components of the vehicle, as is well known in the automotive electronics field. CCM 22 receives information from one or more vehicle systems via CAN bus 42 and, based upon the information, instructs camera 12 to enter either the long range mode or the short range mode. In the long range mode, a determination by CCM 22 that an object is a collision threat may be communicated to any vehicle electronic systems interfaced with CAN bus 42, where it may be used as an input in directing a function change in the appropriate vehicle system(s). For example, a rear-pointing warning light 44 may be illuminated in order to alert the driver of an approaching vehicle that constitutes the collision threat.

The object detection and/or object ranging capabilities of camera 12 and CCM 22 may also be utilized by a parking assist system 46. Such systems are well known in the art and typically utilize one or more sensors (optical, ultrasonic, RF radar, LIDAR, etc.) to determine whether a potential parking space is large enough to accepts the vehicle. Some parking assist systems then direct the driver and/or control the vehicle steering and/or the powertrain system as necessary to direct or move the vehicle into the parking space.

While movable mount 16 as shown in FIG. 2 enables movement of camera 12 between the long range view and short range view positions by means of a rotation about a lateral axis of the vehicle, movement between the two positions may be achieved by rotating and/or translating camera 12 in any number of different ways or combinations of ways, all of which are within the scope of the claims.

In the transition between the long range and short range modes, camera 12 may undergo changes in addition to shifting the pointing angle. For example, the focal distance and/or depth of field of the camera optics may be altered when transitioning between the two modes. Other optical characteristics may be changed to achieve the desired image quality, as will be apparent to persons of skill in the art.

FIG. 5 illustrates an alternative manner in which an electro-optical imaging device may transition between the long range view and short range view modes. Camera 112 comprises a main body 114 that is fixed relative to vehicle 10. Short range lens 116a and long range lens 116b are fixed relative to main body 114 and are oriented to provide the correct pointing angles and fields-of-view that are desired for the respective modes of operation. Short range lens 116a has optical characteristics suitable for the short range detection task, and long range lens 116b has optical characteristics suitable for the collision detection task.

An image capturing element 120, such as a CMOS panel or other suitable device, is mounted within main body 114 to be movable between a short range position as shown in FIG. 5B wherein its imaging plane is properly aligned with the focal plane of short range lens 116a, and a long range position as shown in FIG. 5A wherein its imaging plane is properly aligned with the focal plane of long range lens 116b. Image capturing element may be movable by means of a solenoid or other suitable motive device.

In the short range mode, the aperture of short range lens 116a is open, the aperture of long range lens 116b is closed, and image capturing device 120 is moved to the short range position so that it receives the image. In the long range mode, the aperture of long range lens 116b is open, the aperture of short range lens 116a is closed, and image capturing device 120 is moved to the long range position. Short and long range lenses provide the correct pointing angles and fields-of-view that are desired for the respective modes of operation.

It will be understood by a person of skill in the art that the system architectures depicted in FIGS. 3 and 4 are for clarity of description and are not intended to limit the scope of the present invention, as many other system architectures are possible. For example, the functions performed by the separate electronic control modules depicted may be combined or distributed into any number of electronic control modules installed in the vehicle. Also, CCM 22 need not be a physically separate unit, but may be a function or process integrated with or residing on RCM 24, PCM 26, or other electronic control module(s) of the vehicle.

While the best mode for carrying out the invention has been described in detail, those familiar with the art to which this invention relates will recognize various alternative designs and embodiments for practicing the invention as defined by the following claims.

What is claimed:

1. A dual-mode rear vision system for an automotive vehicle comprising:
an electro-optical imaging device operable in a short range mode to image a backup region immediately rearward of the vehicle and alternatively operable in a long range mode to image a collision threat region rearward of the backup region, the imaging device assuming the short range mode when the vehicle is in a reverse travel mode and assuming the long range mode when the vehicle is in a non-reverse travel mode; and
at least one electronic control module operable when the vehicle is in the reverse travel mode to analyze imagery from the imaging device and detect a backup hazard, and operable when the vehicle is in the non-reverse travel mode to analyze imagery from the imaging device and detect a collision threat, and operable to direct a function change in at least one vehicle system based on detection of at least one of the collision threat and the backup hazard.

2. The system according to claim 1 further comprising a video display screen displaying images from the imaging device.

3. The system according to claim 1 wherein the at least one vehicle system comprises a driver alerting device and the function change comprises generating a sensory driver alert.

4. The system according to claim 1 wherein the at least one vehicle system comprises an occupant safety system and the function change comprises activation of the occupant safety system.

5. The system according to claim 1 wherein the at least one electronic control module comprises a restraints control module controlling activation of the occupant safety system

6. The system according to claim 1 wherein the at least one vehicle system comprises a braking system and the function change comprises activation of the braking system when the backup hazard is detected.

7. The system according to claim 1 wherein the electronic control module is further operable to provide information to a parking assist system.

8. The system according to claim 1 further comprising a mount enabling movement of the imaging device relative to the vehicle between a first pointing angle when the imaging device is in the short range mode and a second pointing angle when the imaging device is in the long range mode.

9. The system according to claim 1 wherein the imaging device comprises a first lens having a first pointing angle appropriate for the short range mode and a second lens having a second pointing angle appropriate for the long range mode.

10. The system according to claim 1 wherein the at least one electronic control module comprises a camera control module.

11. The system according to claim 10 wherein the at least one electronic control module further comprises a restraints control module.

12. A dual-mode imaging system for a vehicle comprising:
an electro-optical imaging device mountable for movement relative to the vehicle between a backup position wherein the imaging device is oriented to image a backup region rearward of the vehicle and a rear collision mitigation position wherein the imaging device is oriented to image a collision threat region rearward of the backup region when a vehicle powertrain is in a non-reverse travel mode;
a drive unit moving the imaging device to the backup position when the vehicle powertrain is in a reverse travel mode and moving the imaging device to the rear collision mitigation position when the vehicle powertrain is in a non-reverse travel mode; and
at least one electronic control module operable when the vehicle powertrain is in the reverse travel mode to analyze imagery received from the imaging device to detect a backup hazard and to cause generation of a driver alert in response thereto, and further operable when the vehicle powertrain is in the non-reverse travel mode to analyze imagery received from the imaging device to detect a collision threat and to direct a function change in at least one occupant protection system in response thereto.

13. The system according to claim 12 further comprising a video screen for mounting inside of the passenger cabin and displaying imagery received from the imaging device when the vehicle powertrain is in the reverse travel mode.

14. A method of operating a rear vision system for a vehicle comprising the following steps:
detecting a status of a vehicle powertrain as being either a reverse travel mode or a non-reverse travel mode;
upon detection of the reverse travel mode, placing an electro-optical imaging device in a short range mode wherein the imaging device images a region rearward of the vehicle;
upon detection of the non-reverse travel mode, placing the imaging device in a long range mode wherein the imaging device images a collision threat region rearward of the backup region;
when the imaging device is in the short range mode, operating at least one electronic control module to analyze imagery from the imaging device and detect a backup hazard;
when the imaging device is in the long range mode, operating the at least one electronic control module to analyze imagery from the imaging device and detect a collision threat; and
causing a function change in at least one vehicle system based upon detection of at least one of the collision threat and the backup hazard.

15. The method according to claim 14 further comprising displaying imagery from the imaging device on a video display.

16. The method according to claim 14 wherein the step of causing a function change in at least one vehicle system comprises activating a driver alerting device.

17. The method according to claim 14 wherein the step of causing a function change in at least one vehicle system comprises activating a vehicle braking system in response to detection of the backup hazard.

18. The method according to claim 14 wherein the step of causing a function change in at least one vehicle system comprises changing an operating status of an occupant restraint.

19. The method according to claim 14 wherein the step of placing the imaging device in the short range mode comprises moving the imaging device relative to the vehicle to achieve a first pointing angle.

20. The method according to claim 14 wherein the step of placing the imaging device in the short range mode comprises selecting a short range lens having a first field-of-view.
